(19) United States
(12) Patent Application Publication
(10) Pub. No.: US 2011/0134854 A1
(43) Pub. Date: Jun. 9, 2011

(54) MULTI-CHANNEL AND MULTI-INTERFACE MESH ROUTER AND METHOD FOR ASSIGNING CHANNEL ACCORDING TO FIXED DISTRIBUTION SCHEME

(75) Inventors: Yong-Geun HONG, Daejeon (KR); Jung Soo Park, Daejeon (KR); Hyoung Jun Kim, Daejeon (KR); Young-Bae Ko, Gyeonggi-Do (KR); Sung-Hee Lee, Gyeonggi-Do (KR)

(73) Assignee: Electronics and Telecommunications Research Institute, Daejeon (KR)

(21) Appl. No.: 12/899,934

(22) Filed: Oct. 7, 2010

(30) Foreign Application Priority Data
Dec. 8, 2009 (KR) 10-2009-0121306

(51) Int. Cl. H04W 8/22

(52) U.S. Cl. 370/329

(57) ABSTRACT

Provided is multi-channel and multi-interface mesh router and method of assigning a channel according to a fixed distribution scheme. The channel assignment method may configure a neighbor information table, a parent list, and a dependent list through exchanging of information between mesh routers, and may determine a channel assignment order based on the parent list and the dependent list and then assign a channel, beginning with a mesh router selected as a seed node, and sequentially transmit channel assignment information to mesh routers included in the dependent list.

### CROSS-REFERENCE TO RELATED APPLICATION

This application claims the benefit of Korean Patent Application No. 10-2009-0121306, filed on Dec. 8, 2009, in the Korean Intellectual Property Office, the disclosure of which is incorporated herein by reference.

### BACKGROUND

1. Field of the Invention

The present invention relates to a mesh router and method for assigning a channel according to a fixed distribution scheme, and more particularly, to a method of selecting a seed node in a mesh network including a multi-channel and multi-interface mesh routers, and assigning a channel, beginning with a mesh router corresponding to the selected seed node.

2. Description of the Related Art

A mesh router of an initial mesh network has been configured using a single channel and a single interface. However, according to an increase in a network size and a required service bandwidth, a mesh router using the single channel and the single interface had many drawbacks. Accordingly, there was an increasing desire for a mesh router using multiple channels and multiple interfaces. In the case of a channel assignment with respect to the single channel and single interface mesh router, all the mesh routers may use the same channel and has no relation with a mesh network topology. When a mesh router uses multiple channels and multiple interfaces, a plurality of channels may be assigned and a plurality of interfaces may be available. Thus, it may be difficult to assign a channel to the mesh router and a corresponding interface. In particular, a channel assignment with respect to the multi-channel and multi-interface mesh router has a close relation with a network topology. When many different channels are used to decrease signal interference, it is possible to decrease the signal interference, however, a connectivity of a mesh network may be deteriorated. Here, the signal interference may occur when the same channel is used. Conversely, when the same channel is used to enhance the connectivity of the mesh network, a channel efficiency may decrease and the signal interference may also occur. Specifically, the signal interference and the connectivity may have a tradeoff relationship. In general, a channel assignment scheme of a mesh router may be classified into a fixed scheme, a dynamic scheme, or a hybrid scheme depending on whether a channel is changed, and may also be classified into a centralization scheme or a distribution scheme depending on an assignment scheme.

### SUMMARY

An aspect of the present invention provides a multi-channel and multi-interface mesh router and a method that may assign a channel according to a fixed distribution scheme.

Another aspect of the present invention also provides a method that may select a seed node in a mesh network including multi-channel and multi-interface mesh routers, and may assign a channel, beginning with a mesh router corresponding to the selected seed node.

Another aspect of the present invention also provides a channel assignment method that may configure a neighbor information table, a parent list, and a dependent list through exchanging of information between mesh routers, and may determine a channel assignment order based on the parent list and the dependent list and then assign a channel, beginning with a mesh router selected as a seed node, and sequentially transmit channel assignment information to mesh routers included in the dependent list, thereby enabling all the mesh routers to minimize interference and to maintain a connectivity.

According to an aspect of the present invention, there is provided a mesh router, including: a neighbor information verifying unit to obtain information associated with mesh routers included in a mesh network by transmitting and receiving a hello message to and from the mesh routers included in the mesh network, and to generate a neighbor information table; a seed node verifying unit to determine a priority of the mesh routers included in the mesh network based on the neighbor information table, and to generate a parent list including adjacent mesh routers having a priority higher than the mesh router, and a dependent list including adjacent mesh routers having a priority lower than the mesh router; and a channel assignment unit to assign a channel to mesh routers included in the dependent list when the mesh router has a highest priority.

According to another aspect of the present invention, there is provided a mesh router, to including: a neighbor information verifying unit to obtain information associated with mesh routers included in a mesh network by transmitting and receiving a hello message to and from the mesh routers included in the mesh network, and to generate a neighbor information table; a seed node verifying unit to determine a priority of the mesh routers included in the mesh network based on the neighbor information table, and to generate a parent list including adjacent mesh routers having a priority higher than the mesh router, and a dependent list including adjacent mesh routers having a priority lower than the mesh router; and a channel assignment unit to receive a channel assignment from all the mesh routers included in the parent list, and to assign a channel to mesh routers included in the dependent list.

According to still another aspect of the present invention, there is provided a channel assignment method of a mesh router, including: obtaining information associated with mesh routers included in a mesh network by transmitting and receiving a hello message to and from the mesh routers included in the mesh network, and generating a neighbor information table; determining a priority of the mesh routers included in the mesh network based on the neighbor information table; generating a parent list including adjacent mesh routers having a priority higher than the mesh router; generating a dependent list including adjacent mesh routers having a priority lower than the mesh router; and assigning a channel to mesh routers included in the dependent list when the mesh router has a highest priority.

According to yet another aspect of the present invention, there is provided a channel assignment method of a mesh router, including: obtaining information associated with mesh routers included in a mesh network by transmitting and receiving a hello message to and from the mesh routers included in the mesh network, and generating a neighbor information table; determining a priority of the mesh routers included in the mesh network based on the neighbor information table; generating a parent list including adjacent mesh routers having a priority higher than the mesh router; generating a dependent list including adjacent mesh routers having a priority lower than the mesh router; and receiving a channel assignment from all the mesh routers included in the parent list, and assigning a channel to mesh routers included in the dependent list.

### EFFECT

According to embodiments of the present invention, there may be provided a multi-channel and multi-interface mesh router and method that may generate a parent list, and a dependent list through exchanging of information between mesh routers, and may determine a channel assignment order based on the parent list and the dependent list and then assign a channel, beginning with a mesh router selected as a seed node, and sequentially transmit channel assignment information to mesh routers included in the dependent list. Accordingly, a channel assignment may be performed so that all the mesh routers may minimize interference and maintain a connectivity.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a mesh router assigning a channel according to an embodiment of the present invention;

FIGS. 2A and 2B are diagrams illustrating a process of obtaining neighbor information in a mesh network according to an embodiment of the present invention;

FIGS. 3A, 3B, and 3C are diagrams illustrating a process of assigning a channel in a mesh network according to an embodiment of the present invention; and

FIG. 4 is a flowchart illustrating a method of assigning a channel by a mesh router according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to an embodiment of the present invention, there is provided a channel assignment method that may configure a neighbor information table, a parent list, and a dependent list through exchanging of information between mesh routers, and may determine a channel assignment order based on the parent list and the dependent list and then assign a channel, beginning with a mesh router selected as a seed node, and sequentially transmit channel assignment information to mesh routers included in the dependent list, thereby enabling all the mesh routers to minimize interference and to maintain a connectivity.

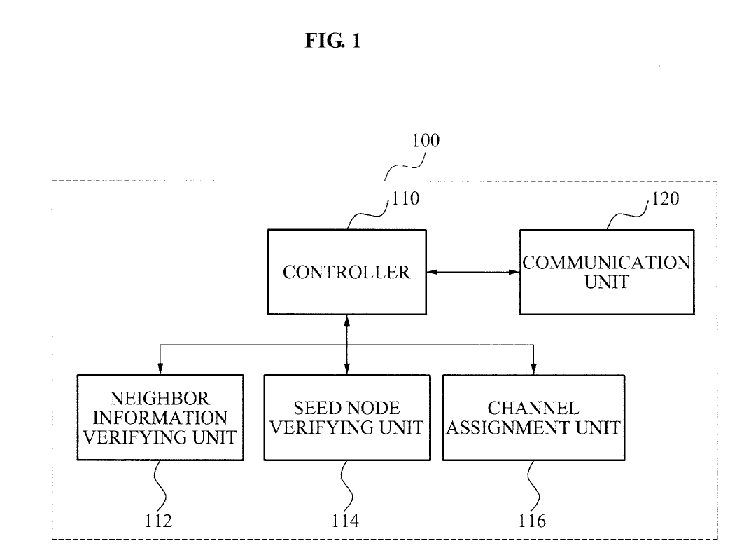

FIG. 1 is a block diagram illustrating a configuration of a mesh router 100 assigning a channel according to an embodiment of the present invention.

Referring to FIG. 1, the mesh router 100 may include a controller 110, a neighbor information verifying unit 112, a seed node verifying unit 114, a channel assignment unit 116, and a communication unit 120.

The communication unit 120 may transmit and receive a hello message, and may also transmit and receive a channel assignment message.

The neighbor information verifying unit 112 may obtain information associated with mesh routers included in a mesh network by transmitting and receiving a hello message to and from the mesh routers included in the mesh network at predetermined intervals, and may generate a neighbor information table based on the obtained information.

The hello message may include channel assignment information required for a channel assignment, and routing information that is associated with routing to be used together with the channel assignment. In this instance, the channel assignment information may include degree information indicating a number of mesh routers adjacent to the mesh router 100 transmitting the hello message.

The neighbor information table may include a Media Access Control (MAC) address, a lifetime, channel assignment information, and routing information with respect to each of the mesh routers included in the mesh network. The MAC address denotes a MAC address of a using interface, the lifetime denotes a period of time where a table value is maintained, the routing information denotes information required for the routing, and the channel assignment information denotes information required for the channel assignment. The channel assignment information may include degree information indicating the number of adjacent mesh routers and channel information of the hello message to be used.

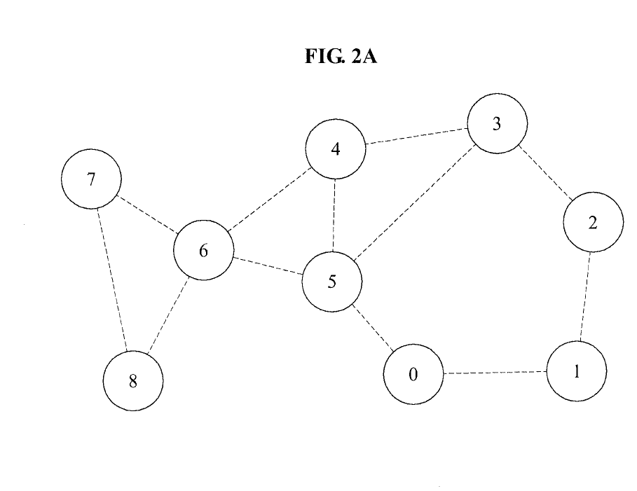

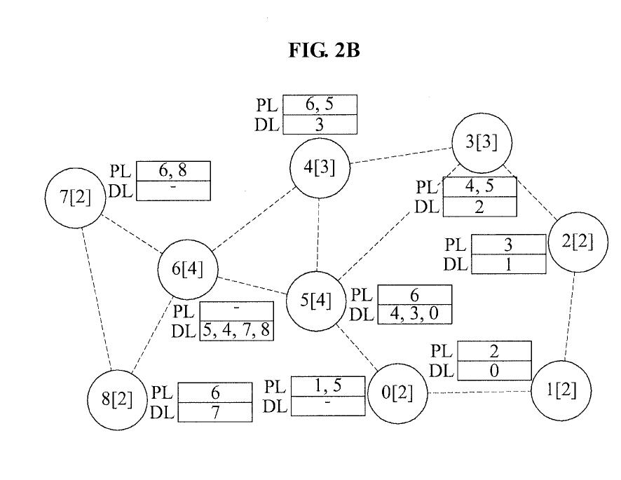

The seed node verifying unit 114 may determine a priority of mesh routers included in the mesh network based on the neighbor information table, and may generate a parent list and a dependent list based on the determined priority, as shown in FIG. 2.

The seed node verifying unit 114 may assign a relatively high priority to a mesh router having a relatively high degree. When mesh routers have the same degree, the seed node verifying unit 114 may assign a relatively high priority to a mesh router of which identification information is greater or to a mesh router of which identification information is smaller.

The seed node verifying unit 114 may include, in the parent list, adjacent mesh routers having a priority higher than the corresponding mesh router 100. That the priority is high, that is, that the degree is high, indicates that a large number of mesh routers are adjacent to the mesh router 100. Accordingly, it may be highly probable that a mesh router having a relatively high degree needs to perform a relay function for other mesh routers. Thus, there is a need to increase a channel use rate.

The seed node verifying unit 114 may include, in the dependent list, adjacent mesh routers having a priority lower than the mesh router 100. When a mesh router included in the parent list of the mesh router 100 does not exist, the seed node verifying unit 114 may determine the mesh router 100 as a seed node.

FIGS. 2A and 2B are diagrams illustrating a process of obtaining neighbor information in a mesh network according to an embodiment of the present invention.

FIG. 2A illustrates an interface connection relationship between mesh routers before obtaining neighbor information, and FIG. 2B illustrates a parent list and a dependent list determined based on neighbor information. In figures, the parent list is represented by PL and the dependent list is represented by DL.

In FIGS. 2A and 2B, each mesh router is represented by a circle, and a number included in each circle denotes identification information of each corresponding mesh router. [] denotes a degree of each corresponding mesh router.

Referring to FIG. 2B, between No. 6 mesh router and No. 5 mesh router having a highest degree, the No. 6 mesh router having a relatively greater identification information value may be determined as a seed node having a highest priority. Accordingly, it can be seen that no mesh router information is included in a parent list of the No. 6 mesh router.

Also, as shown in FIGS. 2A and 2B, a parent list and a dependent list of each mesh router may not include any adjacent mesh router, or may include a single or at least one adjacent mesh router.

The channel assignment unit 116 may receive a channel assignment message from a mesh router included in a corresponding parent list, set according to a priority, and may be assigned with a channel of an interface with the mesh router included in the parent list, as a channel included in the channel assignment message.

When the channel assignment unit 116 receives a channel assignment from all the mesh routers included in the parent list, the channel assignment unit 116 may assign a channel to the interface with a mesh router included in a dependent list, set according to the priority, and may transmit, to the mesh router included in the dependent list, a channel assignment message containing channel information associated with the assigned channel.

When the channel is assigned as described above, a mesh router corresponding to a seed node may initially be assigned with the channel among mesh routers included in the mesh network, and then the channel assignment may be performed according to a priority.

For example, when the mesh router 100 corresponds to the seed node having the highest priority, a parent list of the mesh router 100 may not include any mesh router and thus the channel assignment unit 116 may assign a channel to a mesh router included in the dependent list. When the mesh router 100 does not correspond to the seed node, the channel assignment unit 116 may assign a channel to the mesh router included in the dependent list after the channel assignment is completed with respect to all the mesh routers included in the parent list.

The channel assignment unit 116 may randomly assign a channel among available channels, or may select and assign a channel in a round-robin form for each interface of each mesh router.

When performing the channel assignment, the channel assignment unit 116 may generate a priority channel list for each interface of each mesh router and thereby assign a channel. The priority channel list may include a single connection channel and additionally include at least one candidate channel. In this instance, the connection channel denotes a channel used for the channel assignment, and the candidate channel denotes a channel used when the connection channel malfunctions. The channel assignment unit 116 may include the priority channel list in the channel assignment message and thereby transmit the channel assignment message to the mesh router included in the dependent list.

The controller 110 may control the neighbor information verifying unit 112, the seed node verifying unit 114, and the channel assignment unit 116. Specifically, the controller 110 may perform functions of the neighbor information verifying unit 112, the seed node verifying unit 114, and the channel assignment unit 116. The above constituent elements are separately illustrated in figures for clear descriptions. Accordingly, when a product is actually configured, all of the above constituent elements may be configured to be processed in the controller 110. Also, only a portion thereof may be configured to be processed in the controller 110.

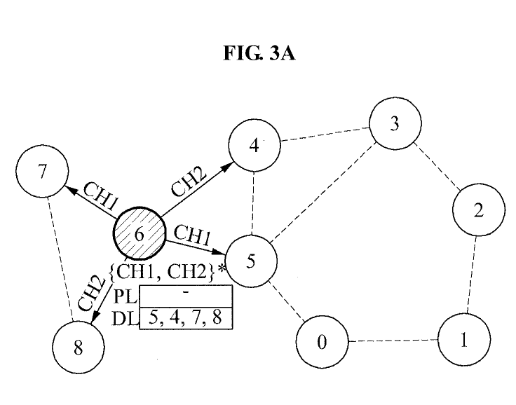

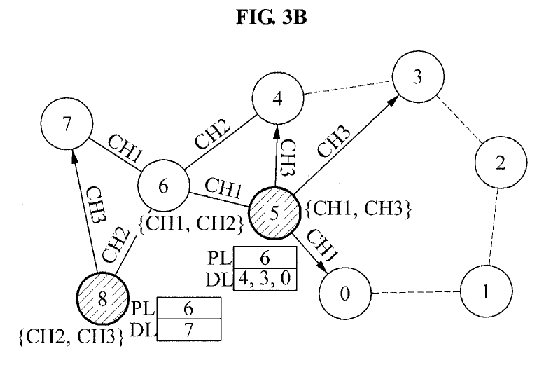

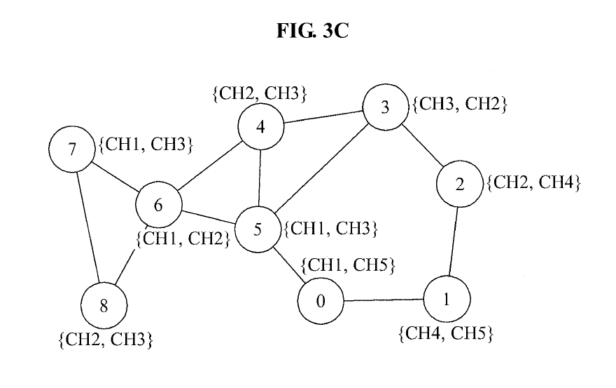

FIGS. 3A, 3B, and 3C are diagrams illustrating a process of assigning a channel in a mesh network according to an embodiment of the present invention.

FIG. 3A illustrates a process of assigning a channel by a mesh router corresponding to a seed node. Referring to FIG. 3A, No. 6 mesh router that is the seed node may assign a channel by transmitting a priority channel list, including channels CH1 and CH2, to No. 5 mesh router, No. 4 mesh router, No. 7 mesh router, and No. 8 mesh router included in a dependent list.

FIG. 3B illustrates a process of assigning, by a mesh router, a channel to mesh routers included in a dependent list of the mesh router. Referring to FIG. 3B, the No. 5 mesh router assigned with a channel from the No. 6 mesh router included in a parent list of the No. 5 mesh router may assign a channel by transmitting a priority channel list, including channels CH1 and CH3, to No. 4 mesh router, No. 3 mesh router, and No. 0 mesh router included in a dependent list of the No. 5 mesh router.

Also, the No. 8 mesh router assigned with a channel from the No. 6 mesh router included in a parent list of the No. 8 mesh router may assign a channel by transmitting a priority channel list, including channels CH2 and CH3, to the No. 7 mesh router included in a dependent list of the No. 8 mesh router.

FIG. 3C illustrates a mesh network where a channel assignment is completed. When mesh routers are assigned with a channel from all the parent lists, a channel assignment may be performed with respect to mesh routers included in dependent lists.

Hereinafter, a method of assigning a channel according to a fixed distribution scheme in a multi-channel and multi-interface mesh router according to an embodiment of the present invention will be described.

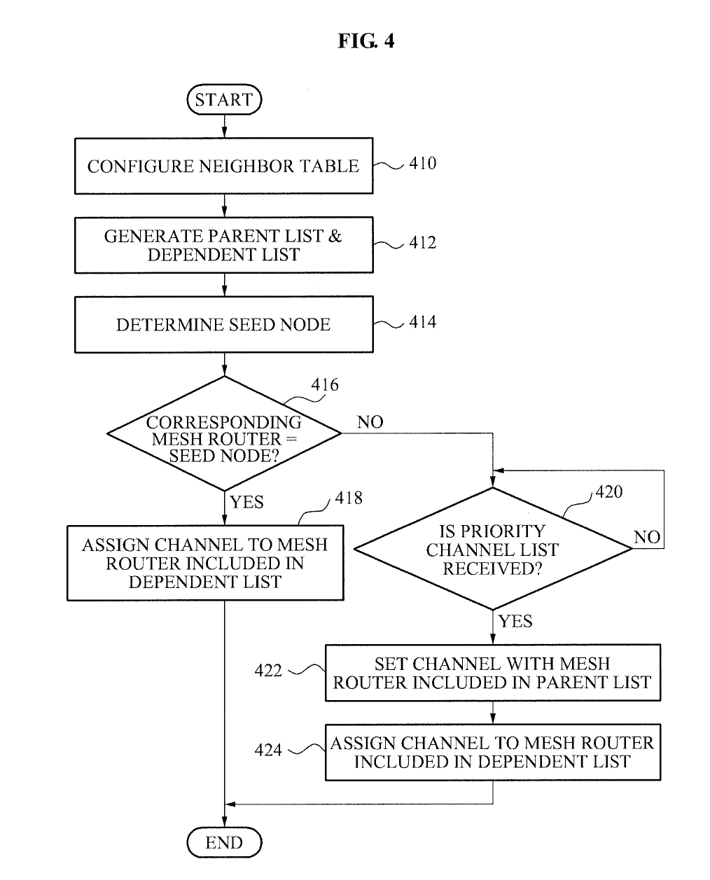

FIG. 4 is a flowchart illustrating a method of assigning a channel by the mesh router 100 of FIG. 1 according to an embodiment of the present invention.

Referring to FIG. 4, in operation 410, the mesh router 100 may generate a neighbor information table by transmitting and receiving a hello message.

In operation 412, the mesh router 100 may generate a parent list and a dependent list based on the neighbor information table. The parent list may include adjacent mesh routers having a priority higher than the mesh router 100. The dependent list may include mesh routers having a priority lower than the mesh router 100.

In operation 414, the mesh router 100 that does not include any mesh router in its parent list, that is, has a highest priority may be determined as a seed node. In operation 416, whether the corresponding mesh router 100 corresponds to the seed node may be verified.

When the corresponding mesh router 100 corresponds to the seed node, the mesh router 100 may assign a channel to a mesh router included in a dependent list of the mesh router 100 in operation 418.

Conversely, when the corresponding mesh router 100 does not correspond to the seed node, the mesh router 100 may verify whether a channel assignment message including a priority channel list is received from the mesh router included in the parent list of the mesh router 100 in operation 420.

When the channel assignment message is received, the mesh router 100 may set a channel with the mesh router having transmitted the channel assignment message in operation 422.

When the mesh router 100 is assigned with a channel from all the mesh routers included in the parent list of the mesh router 100 in operation 424, the mesh router 100 may assign a channel to mesh routers included in the dependent list of the mesh router 100, set according to a priority, and may transmit a channel assignment message including information associated with the assigned channels to the mesh routers included in the dependent list of the mesh router 100.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mesh router, comprising:
a neighbor information verifying unit to obtain information associated with mesh routers included in a mesh network by transmitting and receiving a hello message to and from the mesh routers included in the mesh network, and to generate a neighbor information table;
a seed node verifying unit to determine a priority of the mesh routers included in the mesh network based on the neighbor information table, and to generate a parent list including adjacent mesh routers having a priority higher than the mesh router, and a dependent list including adjacent mesh routers having a priority lower than the mesh router; and
a channel assignment unit to assign a channel to mesh routers included in the dependent list when the mesh router has a highest priority.

2. The mesh router of claim 1, wherein the hello message comprises degree information indicating a number of mesh routers adjacent to the mesh router, and routing information for routing.

3. The mesh router of claim 1, wherein the neighbor information table comprises a Media Access Control (MAC) address of each mesh router, a lifetime where the neighbor information table is maintained, degree information indicating a number of mesh routers adjacent to the mesh router, channel information of the hello message used by each mesh router, and routing information for routing.

4. The mesh router of claim 1, wherein the seed node verifying unit assigns a higher priority as a value of a degree indicating a number of adjacent mesh routers is greater.

5. The mesh router of claim 4, wherein when mesh routers having the same value of the degree exist, the seed node verifying unit assigns a higher priority to a mesh router of which a value of identification information is greater or smaller, according to a priority assignment scheme that is predetermined based on identification information of each mesh router.

6. The mesh router of claim 1, wherein when the mesh router does not have the highest priority, the channel assignment unit receives a channel assignment from all the mesh routers included in the parent list, and assigns the channel to mesh routers included in the dependent list.

7. The mesh router of claim 1, wherein the channel assignment unit assigns the channel by transmitting, using a channel assignment message, a priority channel list including a single connection channel and at least one candidate channel.

8. A mesh router, comprising:
a neighbor information verifying unit to obtain information associated with mesh routers included in a mesh network by transmitting and receiving a hello message to and from the mesh routers included in the mesh network, and to generate a neighbor information table;
a seed node verifying unit to determine a priority of the mesh routers included in the mesh network based on the neighbor information table, and to generate a parent list including adjacent mesh routers having a priority higher than the mesh router, and a dependent list including adjacent mesh routers having a priority lower than the mesh router; and
a channel assignment unit to receive a channel assignment from all the mesh routers included in the parent list, and to assign a channel to mesh routers included in the dependent list.

9. The mesh router of claim 8, wherein the seed node verifying unit assigns a higher priority as a value of a degree indicating a number of adjacent mesh routers is greater.

10. The mesh router of claim 9, wherein when mesh routers having the same value of the degree exist, the seed node verifying unit assigns a higher priority to a mesh router of which a value of identification information is greater or smaller, according to a priority assignment scheme that is predetermined based on identification information of each mesh router.. to 11. A channel assignment method of a mesh router, comprising:
obtaining information associated with mesh routers included in a mesh network by transmitting and receiving a hello message to and from the mesh routers included in the mesh network, and generating a neighbor information table;
determining a priority of the mesh routers included in the mesh network based on the neighbor information table;
generating a parent list including adjacent mesh routers having a priority higher than the mesh router;
generating a dependent list including adjacent mesh routers having a priority lower than the mesh router; and
assigning a channel to mesh routers included in the dependent list when the mesh router has a highest priority.

12. The method of claim 11, wherein the hello message comprises degree information indicating a number of mesh routers adjacent to the mesh router, and routing information for routing.

13. The method of claim 11, wherein the neighbor information table comprises a MAC address of each mesh router, a lifetime where the neighbor information table is maintained, degree information indicating a number of mesh routers adjacent to the mesh router, channel information of the hello message used by each mesh router, and routing information for routing.

14. The method of claim 11, wherein the determining comprises assigning a higher priority as a value of a degree indicating a number of adjacent mesh routers is greater.

15. The method of claim 14, wherein the determining comprises assigning a higher priority to a mesh router of which a value of identification information is greater or smaller, according to a priority assignment scheme that is predetermined based on identification information of each mesh router, when mesh routers having the same value of the degree exist.

16. The method of claim 11, wherein the assigning comprises receiving a channel assignment from all the mesh routers included in the parent list, and assigning the channel to mesh routers included in the dependent list when the mesh router does not have the highest priority.

17. The method of claim 11, wherein the assigning comprises assigning the channel by transmitting, using a channel assignment message, a priority channel list including a single connection channel and at least one candidate channel.

18. A channel assignment method of a mesh router, comprising:
obtaining information associated with mesh routers included in a mesh network by transmitting and receiving a hello message to and from the mesh routers included in the mesh network, and generating a neighbor information table;
determining a priority of the mesh routers included in the mesh network based on the neighbor information table;
generating a parent list including adjacent mesh routers having a priority higher than the mesh router;
generating a dependent list including adjacent mesh routers having a priority lower than the mesh router; and
receiving a channel assignment from all the mesh routers included in the parent list, and assigning a channel to mesh routers included in the dependent list.

19. The method of claim 18, wherein the determining comprises assigning a higher priority as a value of a degree indicating a number of adjacent mesh routers is greater.

20. The method of claim 19, wherein the determining comprises assigning a higher priority to a mesh router of which a value of identification information is greater or smaller, according to a priority assignment scheme that is predetermined based on identification information of each mesh router, when mesh routers having the same value of the degree exist.
